(19) United States
(12) Patent Application Publication
(10) Pub. No.: US 2007/0222355 A1
(43) Pub. Date: Sep. 27, 2007

(54) CATHODE PLATE OF FIELD EMISSION DISPLAY DEVICE AND FABRICATION METHOD THEREOF

(76) Inventors: Te-Hao Tsou, Taoyuan County (TW); Jane-Hway Liao, Hsinchu County (TW); Yau-Chen Jiang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,482

(22) Filed: Aug. 11, 2006

(30) Foreign Application Priority Data
Mar. 21, 2006 (TW) 95109590

(51) Int. Cl. H01J 1/00; H01J 19/06; H01J 9/12; B05D 5/12

(52) U.S. Cl. 313/311; 313/310; 445/50; 445/51; 427/77

(57) ABSTRACT

The present invention provides a cathode plate of the field emission display and the fabrication method thereof. The emission layer is formed on the electrode layer within the trench in a self-aligned way by screen printing or ink-jetting. Since the emission layer is accurately aligned with the electrode layer, the pattern quality is improved and the overflow or disrupture problems in screen printing are alleviated.

### CROSS-REFERENCE TO RELATED APPLICATION

This application claims the priority benefit of Taiwan application serial no. 95109590, filed on Mar. 21, 2006. All disclosure of the Taiwan application is incorporated herein by reference.

### BACKGROUND OF THE INVENTION

1. Field of the Invention

The present invention relates to a field emission display device and the fabrication method thereof. More particularly, the present invention relates to a cathode plate of a field emission display device and the fabrication method thereof.

2. Description of the Related Art

The field emission display (FED) technology, similar in operation to the conventional cathode ray tube (CRT) display, is a flat-panel display technology. One characteristic of the FED is spontaneous light emission, thus no backlight is required. Moreover, the FED offers high brightness comparable to the CRTs under low working voltages. Other advantages of the FED include better environmental endurance, rapid response rate and less view-angle problems.

The FED device can be categorized as Spindt type, surface conduction electron emitter display (SCE) type, carbon nanotube (CNT) type, or ballistic electron surface emitting display (BSD) type, depending on the emitting mechanisms. The material of the electron emission layer for the CNT type FED employs carbon nanotube (CNT) materials. In general, the CNT material can be fabricated, for example, by using arc evaporation, graphite laser ablation or the chemical vapor deposition (CVD) process. The emission layer made of carbon nanotube (CNT) is formed by using the aforementioned process to form the CNT material, transforming the CNT material into a paste and then screen-printing the CNT paste on the electrode layer. Because the screen-printing technology is simple, inexpensive and suitable for large-area mass production, it helps to reduce the fabrication costs of the CNT type FED devices.

However, during the process of screen-printing the CNT layer, if the CNT paste is not viscous enough and runny, the paste would overflow and spill over. On the other hand, if the paste is too thick or the line-width of the pattern is small, the paste may easily get clotted and cause discontinuous lines/disruptures or incomplete patterns. Furthermore, the forces exerted by the scraper can cause deformation of the screen plate, which leads to misalignment of the emission layer relative to the electrode layer and deteriorates the printing quality. In addition, due to the potential misalignments, the line-width of the emission layer may have to be adjusted to alleviate the pattern shifting out of the electrode layer.

Since the field emission characteristics are closely related to the accuracy of the alignment between the emission layer and the electrode layer, it is important to precisely coat the patterned CNT layer onto the electrode layer.

### SUMMARY OF THE INVENTION

Accordingly, at least one objective of the present invention is to provide a cathode plate of a field emission display device and the fabrication method thereof, by forming the conductive electrode layer and the emission layer in the trenches of the substrate. Hence, the prior problems of overlow or disrupture can be alleviated or prevented.

At least another objective of the present invention is to provide a method of fabricating a field emission display device and a cathode plate thereof, using the screen-printing or ink-jetting process to coat the carbon nanotube layer on the electrode layer in the trench in a self-aligned way. Therefore, the alignment between the emission layer and the electrode layer is improved and misalignment is avoided

At least another of the present invention is to provide a cathode plate and a field emission display device using the same. The electrode layer and the emission layer of the cathode plate are disposed in the trenches of the substrate and precisely self-aligned, thus preventing the prior shifting problems in related to screen-printing or ink-jet.

To achieve these and other advantages and in accordance with the purpose of the invention, as embodied and broadly described herein, this invention provides a method of forming a cathode plate comprising the following steps. After providing a substrate having a plurality of trenches therein, an electrode layer is formed on the bottom surface of each trench and an emission layer is then formed on the electrode layer in each trench.

According to one embodiment of this invention, the method of forming a cathode plate comprises the following steps. After a substrate is provided, a patterned mask layer is formed over the substrate. Using the patterned mask layer as a mask, the substrate is etched to form a plurality of trenches in the substrate. Then, an electrode layer is blanketly formed over the substrate. After the patterned mask layer is removed, the electrode layer on the patterned mask layer is also removed and the electrode layer on the bottom surfaces of the trenches is remained. Then, an emission layer is formed on the electrode layer in the trenches.

The present invention also provides a cathode plate, suitable for a field emission display device. The cathode plate includes a substrate having a plurality of trenches, an electrode layer disposed on the bottom surface of each trench and a carbon nanotube emission layer disposed on the electrode layer in each trench. The upper surface of the emission layer is lower than that of the substrate.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1F are schematic cross-sectional views showing the steps for forming a field emission display device and its cathode plate according to one embodiment of the present invention.

FIG. 2 is an enlarged, schematic cross-sectional view showing the step of screen-printing the emission layer of the cathode plate according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention relates to a field emission display device and its cathode plate, and the fabrication method thereof. The cathode plate is formed by forming trenches in the substrate and forming the electron emission layer on the electrode layer in the trenches in a self-aligned way.

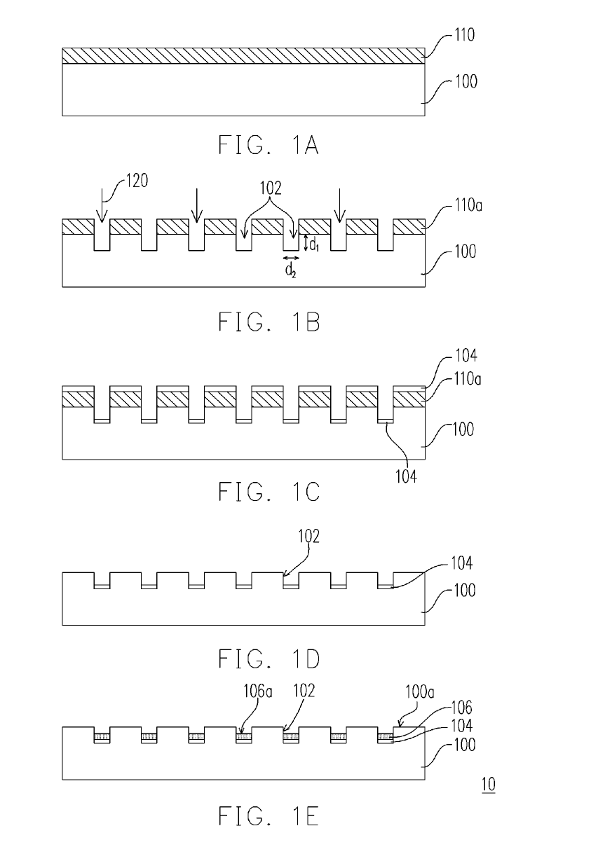

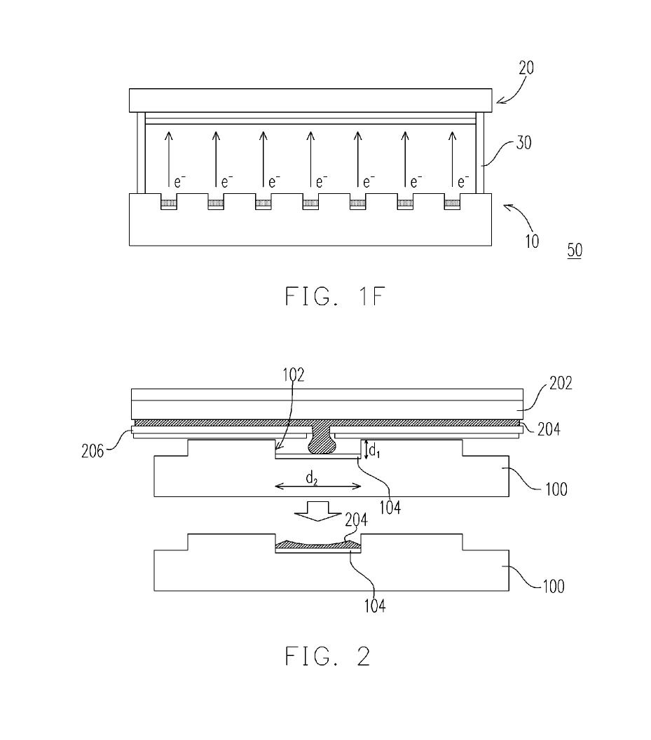

FIGS. 1A through 1F are schematic cross-sectional views showing the steps for forming a field emission display device and its cathode plate according to one embodiment of the present invention. FIG. 2 is an enlarged, schematic cross-sectional view showing the step of screen-printing the emission layer of the cathode plate according to one embodiment of the present invention.

As shown in FIG. 1A, a substrate 100 is provided. The substrate 100 is fabricated using glass, for example. For example, in the fabrication of a 20-inch panel, a 20-inch (370 mm×470 mm×2.8 mm) glass is used as the bottom substrate. Alternatively, the substrate 100 can be a plastic substrate, a ceramic substrate or a silicon substrate. A mask layer 110 is formed over the substrate 100, with a thickness of about 2˜10 μm, for example. The mask layer 110 can be a photoresist layer or a photosensitive material layer, for example.

Referring to FIG. 1B, the mask layer 110 is exposed and developed to form the patterned mask layer 110a. Using the patterned mask layer 110a as an etching mask, an etching process 120 is performed to remove the substrate that is not covered by the patterned mask layer 110a, so as to form a plurality of trenches 102 in the substrate 100. The etching process 120 can be a wet etching process using buffered oxidation etchant (BOE) solution or HF as the etchant, for example. The pattern layout or design of the trenches 102 can be varied according to the design requirements of the FED. For example, the depth d1 of the trench 102 can be 5˜20 μm, or adjusted based on the thickness of the substrate or the electrode layer, while the width d2 of the trench 102 can be about 50˜200 μm or tuned according to the pattern design.

As shown in FIG. 1C, an electrode layer 104 is formed over the substrate 100 and the patterned mask layer 110a. For example, the electrode layer 104 is blanketly formed over the substrate 100 by sputtering. The electrode layer 104 can be a metal layer, for example, a silver electrode layer having a thickness of about 0.2˜0.5 μm.

As shown in FIG. 1D, the patterned mask layer 110a is removed. During the removal of the patterned mask layer 110a, the electrode layer 104 disposed on the patterned mask layer 110 is also removed, while the electrode layer 104 disposed in the trenches 102 is remained.

Referring to FIG. 1E, an emission layer 106 is formed on the electrode layer 104 within the trenches 102. After the sintering process, a cathode plate 10 is obtained. The obtained cathode plate 10 includes the substrate 100 having a plurality of trenches 102 and, within each trench 102, an electrode layer 104 is disposed on the bottom surface of the trench 102 and an emission layer 106 disposed on the electrode layer 104. The upper surface 106a of the emission layer 106 is lower than the top surface 100a of the substrate 100.

The emission layer 106 is, for example, a carbon nanotube (CNT) layer having a thickness of about 5˜10 μm. The CNT layer can be fabricated by any known methods, for example, by using arc evaporation, graphite laser ablation or the chemical vapor deposition (CVD) process. The emission layer 106 is formed, for example, using the aforementioned process to form the carbon nanotube (CNT), transforming the CNT material into a paste and then screen-printing or ink-jetting the CNT paste on the electrode layer.

Taking the screen-printing process as an example, as shown in FIG. 2, because the trench 102 is lower than the substrate 100, the paste 204 is swept through the screen plate 202 into the trench 102 and the paste 204 is self-aligned to the electrode layer 104 within the trench 102, as the scraper 202 sweeps along the screen plate 202. Since the electrode layer 104 is disposed within the trench 102, the paste 204 for forming the emission layer will be limited by the sidewalls of the trench 102 and distribute evenly over the electrode layer 104 without prior overflow problems. Because the formed emission layer is self-aligned to the underlying electrode layer, the quality of the pattern transferred through screen-printing or ink-jetting is improved. Further, for the ink-jetting process, the injected ink (paste) will be restricted by the trenches, so that prior art problems of blurring or inferior quality of pattern edges can be alleviated and the pattern quality of ink-jetting is improved. For either the screen-printing or ink-jetting process, since the paste swept or injected into the trenches 102 is self-aligned to the electrode layer therein, the process window and the alignment tolerance become larger, thus increasing the alignment accuracy and lowering the production costs.

As shown in FIG. 1F, after forming the cathode plate 10, an anode plate 20 and a plurality of supporters 30 are provided. The supporters 30 are disposed between the cathode plate 10 and the anode plate 20 and the ends of the supports 30 are attached to the cathode plate 10 and the anode plate 20 to form a complete field emission display device 50.

According the method of forming the cathode plate in the present invention, the emission layer is formed on the electrode layer within the trench 102 of the substrate 100, so that the electrode layer and the emission layer are self-aligned without overflow problems. Not only the pattern quality is enhanced but also the alignment accuracy is increased. Furthermore, it simplifies the fabrication processes and reduces the production costs for the cathode plate. Moreover, the misalignment in the screen-printing process is significantly reduced and overall reliability of the device is increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of forming a cathode plate suitable for a field emission display device, comprising the steps of:
providing a substrate;
forming a patterned mask layer over the substrate;
etching the substrate using the patterned mask layer as a mask to form a plurality of trenches in the substrate;
forming an electrode layer over the patterned mask layer and bottom surfaces of the trenches of the substrate;
removing the patterned mask layer to remove the electrode layer over the patterned mask layer, so that the electrode layer over the bottom surfaces of the trenches is remained; and
forming an emission layer on the electrode layer over the bottom surfaces of the trenches.

2. The method of claim 1, wherein a material of the emission layer comprises a carbon nanotube (CNT) material.

3. The method of claim 2, wherein the step of forming the emission layer comprises:
churning the carbon nanotube material to form a paste and coating the paste over the patterned electrode layer by a screen-printing process to form a carbon nanotube layer that serves as the emission layer on the electrode layer.

4. The method of claim 2, wherein the step of forming the emission layer comprises:
churning the carbon nanotube material to form a paste and coating the paste over the patterned electrode layer by an ink-jetting process to form a carbon nanotube layer that serves as the emission layer on the electrode layer.

5. The method of claim 1, wherein the step of forming the electrode layer includes forming a silver electrode layer over the substrate by a sputtering process.

6. The method of claim 1, wherein the step of etching the substrate comprises a wet etching process.

7. A method of forming a cathode plate suitable for a field emission display device, comprising the steps of:
providing a substrate having a plurality of trenches therein;
forming an electrode layer over a bottom surface of each trench; and
forming an emission layer on the electrode layer over the bottom surface of each trench.

8. The method of claim 7, wherein the step of providing the substrate having the plurality of trenches comprises:
forming a patterned mask layer over the substrate; and
using the patterned mask layer as a mask, etching the substrate that is not covered by the patterned mask layer to form the plurality of trenches.

9. The method of claim 8, wherein the step of forming the electrode layers comprises:
forming an electrode layer over the patterned mask layer and the bottom surfaces of the trenches of the substrate;and
removing the patterned mask layer to simultaneously remove the electrode layer that is over the patterned mask layer, so that the electrode layer over the bottom surfaces of the trenches is remained.

10. The method of claim 7, wherein a material of the emission layer comprises a carbon nanotube (CNT) material.

11. The method of claim 10, wherein the step of forming the emission layer comprises:
churning the carbon nanotube material to form a paste and coating the paste over the patterned electrode layer by a screen-printing process to form a carbon nanotube layer that serves as the emission layer on the electrode layer.

12. The method of claim 10, wherein the step of forming the emission layer comprises:
churning the carbon nanotube material to form a paste and coating the paste over the patterned electrode layer by an ink-jetting process to form a carbon nanotube layer that serves as the emission layer on the electrode layer.

13. The method of claim 7, wherein the step of forming the electrode layer includes forming a silver electrode layer over the substrate by a sputtering process.

14. The method of claim 8, wherein the step of etching the substrate comprises a wet etching process.

15. A cathode plate suitable for a field emission display device, comprising:
a substrate having a plurality of trenches;
an electrode layer disposed on a bottom surface of each trench; and
a carbon nanotube (CNT) emission layer on the electrode layer in the trench, wherein an upper surface of the CNT emission layer is lower than that of the substrate.

16. The plate of claim 15, wherein a material of the electrode layer includes metal silver.

17. The plate of claim 16, wherein a thickness of the electrode layer is about 0.2˜0.5 microns.

18. The plate of claim 15, wherein the CNT emission layer is formed by a screen-printing process and then a sintering process.

19. The plate of claim 1 5, wherein the CNT emission layer is formed by a ink-jetting process and then a sintering process.

20. The plate of claim 15, wherein a thickness of the CNT emission layer is about 5˜10 microns.

21. The plate of claim 15, wherein the substrate is selected from the group consisting of a glass substrate, a plastic substrate, a ceramic substrate and a silicon substrate.
